(19) United States
(12) Patent Application Publication
(10) Pub. No.: US 2024/0081324 A1
(43) Pub. Date: Mar. 14, 2024

(54) COATED SEEDS AND METHODS OF MAKING SAME

(71) Applicant: Pursell Agri-Tech, LLC, Sylacauga, AL (US)

(72) Inventor: Timothy Gene Holt, Florence, AL (US)

(73) Assignee: Pursell Agri-Tech, LLC, Sylacauga, AL (US)

(21) Appl. No.: 18/244,399

(22) Filed: Sep. 11, 2023

Related U.S. Application Data
(60) Provisional application No. 63/405,543, filed on Sep. 12, 2022.

(51) Int. Cl. A01N 25/10; A01N 25/26; A01N 37/46

(52) U.S. Cl. CPC A01N 25/10; A01N 25/26; A01N 37/46

(57) ABSTRACT

Coated seeds and methods of making the coated seeds are disclosed. The coated seeds may include a core having a seed, such as soybean or corn, and a coating that has a controlled rupture rate.

### FIELD OF THE INVENTION

The present disclosure relates generally to a method of coating seeds and the coated seeds themselves. The method includes providing seeds in a coating unit and applying one or more coating layers to the seeds to form coated seeds that are advantageously protected from insects and harmful environment factors that typically occur outside the growing season. In this regard, the coating provides an insulating barrier against extreme weather conditions, fortification against destructive insects, and/or moisture and freeze protection for seeds that are planted outside of the growing season, e.g., in late fall and winter. Moreover, coated seeds in accordance with the present disclosure may have controllable rupture rates that facilitate germination in the primary growing season. Furthermore, the coating method of the present disclosure may be used to improve shelf-life and stability of the underlying seed.

### BACKGROUND OF THE INVENTION

While there have been significant improvements in agricultural approaches to growing crops, there is still a need for further advancements as it relates to crops that are grown in a variety of geographical areas. For example, Pioneer® brand corn and soybeans may be protected with an insecticide seed treatment, a nematicide seed treatment, a fungicide treatment, or a combination thereof to stave off pests, diseases and uncertain soil conditions during critical early growth. However, such treatments do not address the narrow window available to growers for planting seeds and the logistics that come into play should that narrow window be hampered by weather, equipment failure, labor shortages, or any combination thereof. It would be advantageous to develop a method for protecting seeds that enables a farmer/grower to plant such seeds well in advance of the growing season and/or plant additional acreage for additional production. The present disclosure satisfies such a need and may allow growers to plant at least one season earlier than the germination season.

In addition, there is a need in the art for a method of coating seeds such that the coating forms a protective barrier around the seed to protect the seed from degradation that may occur during shipping and/or storage prior to planting. In particular, uncoated seeds travel from the provider to the grower and then sit in storage for a time prior to planting. Depending on the packaging, weather conditions, and/or storage conditions, the uncoated seed may be subject to some level of degradation before the seeds are in the ground. Moreover, uncoated seeds generally must be planted in the first or initial growing season to avoid loss in the germination rate. It would be advantageous to develop a method for protecting seeds with a coating that provides relatively short-term protection prior to planting or protection that allows planting in a later growing season. The present disclosure satisfies such a need.

### SUMMARY OF THE INVENTION

The present invention is directed to a coated seed, including a core including a seed having a first germination rate; a coating including a polyurethane, where the coating has a rupture rate of at about 20 days to 180 days after being planted in soil, wherein the coated seed has a second germination rate that is substantially equivalent to or better than the first germination rate. In some aspects, the coating has a weight of about 0.3 percent to about 10 percent by weight based on the total weight of the coating. In other aspects, the coating has a weight of about 1 percent to about 8 percent by weight based on the total weight of the coating. In yet other aspects, the coating may about 0.0010 percent to about 20 percent by weight, 0.2 percent to about 15 percent by weight, or about 0.5 percent to about 5 percent by weight based on the total coated seed weight.

In still other aspects, the second germination rate is about 97 percent to about 100 percent of the first germination rate. In yet other aspects, the second germination rate is about 99 percent to about 105 percent of the first germination rate. In still other aspects, the second germination rate is about 100 percent to about 115 percent of the first germination rate. The second germination rate may also be about 97 percent to about 110 percent of the first germination rate.

The present invention is also directed to a coated seed, including a core including a seed having a first germination rate; a coating including a polyurethane, where the coating has a rupture rate of at about 20 days to 180 days after being planted in soil, wherein the coated seed has a second germination rate that is at least 50 percent of the first germination rate. In some aspects, the coating has a weight of about 0.3 percent to about 10 percent by weight based on the total weight of the coating. In other aspects, the coating has a weight of about 1 percent to about 8 percent by weight based on the total weight of the coating. In yet other aspects, the coating may about 0.0010 percent to about 20 percent by weight, 0.2 percent to about 15 percent by weight, or about 0.5 percent to about 5 percent by weight based on the total coated seed weight. In still other aspects, the second germination rate is at least about 60 percent of the first germination rate. In yet other aspects, the second germination rate is at least about 70 percent of the first germination rate.

The present disclosure also relates to a method for coating seeds including the steps of:
feeding a plurality of uncoated seeds into a coating unit, wherein the plurality of uncoated seeds have a first germination rate;
applying a coating layer to each uncoated seed in the plurality of uncoated seeds by:
   disposing a coating layer on each uncoated seed, wherein the coating layer has a first weight, and wherein the coating layer includes the reaction product of one or more coating components;
   partially curing or hardening the coating layer, wherein the step of disposing is performed one or more times to the plurality of uncoated seeds to provide a plurality of coated seeds; and
   discharging the plurality of coated seeds from the coating unit, wherein the plurality of coated seeds have a second germination rate.

In some embodiments, the method further includes a step of performing a final cure or hardening of the coating layer on each coated seed in the plurality of coated seeds, and wherein the step of performing occurs prior to the step of discharging the plurality of coated seeds from the coating unit. In other embodiments, the second germination rate is substantially the same as or greater than first germination rate. In yet other embodiments, the second germination rate is at least 50 percent of the first germination rate. For example, the second germination rate may be at least about 60 percent of the first germination rate. In one aspect, the second germination rate is at least about 70 percent of the first germination rate. In still other embodiments, one or more of the coating components includes a polyisocyanate and an isocyanate-reactive component, and the step of applying a coating layer further includes the steps of:
injecting the isocyanate-reactive component into a bed of the plurality of uncoated seeds;
mixing the isocyanate-reactive component with the plurality of uncoated seeds for about 5 to about 120 seconds;
injecting the polyisocyanate into the bed of the plurality of uncoated seeds;
rolling the plurality of uncoated seeds in the coating unit for about 10 seconds to about 300 seconds, allowing the isocyanate-reactive component and the polyisocyanate to react; and
injecting a liquid wax into the coating unit.

In this aspect, the isocyanate-reactive component may include a polyol. In other aspects, the coating layer may be about 1 percent to about 10 percent by weight of the total weight of a coated seed. In still other aspects, the coating layer may be about 5 percent to about 8 percent by weight of the total weight of a coated seed. In yet other aspects, the coating may about 0.0010 percent to about 20 percent by weight, 0.2 percent to about 15 percent by weight, or about 0.5 percent to about 5 percent by weight based on the total coated seed weight.

### BRIEF DESCRIPTION OF THE DRAWINGS

Further features and advantages can be ascertained from the following detailed description that is provided in connection with the drawings described below:

FIG. 1 is a cross-sectional view of a coated seed according to an embodiment of the present disclosure; and

FIG. 2 is a cross-sectional view of a coated seed according to another embodiment of the present disclosure.

### DETAILED DESCRIPTION

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terms “about” and “approximately” shall generally mean an acceptable degree of error or variation for the quantity measured given the nature or precision of the measurements. Numerical quantities given in this description are approximate unless stated otherwise, meaning that the term “about” or “approximately” can be inferred when not expressly stated.

The terminology used herein is for the purpose of describing particular embodiments only and is not intended to be limiting. As used herein, the singular forms “a”, “an” and “the” are intended to include the plural (i.e., “at least one”) forms as well, unless the context clearly indicates otherwise.

The terms “first”, “second”, and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

Terms such as “at least one of A and B” should be understood to mean “only A, only B, or both A and B.” The same construction should be applied to longer lists (e.g., “at least one of A, B, and C”).

The term “consisting essentially of” means that, in addition to the recited elements, what is claimed may also contain other elements (steps, structures, ingredients, components, etc.) that do not adversely affect the operability of what is claimed for its intended purpose as stated in this disclosure. This term excludes such other elements that adversely affect the operability of what is claimed for its intended purpose as stated in this disclosure, even if such other elements might enhance the operability of what is claimed for some other purpose.

The term “over” as used herein refers to some layer, coating, or component, which is farther from the center of the particle than another. For example, “X is over Y” should be construed to mean that X is farther from the center of the seed than Y. X may be in direct contact with Y (“directly over”), or there may be an intervening distance/and or components. It is contemplated that any instance of the term “over” could be limited to “directly over.”

The present disclosure provides for a method of coating seeds. More specifically, the method of the present disclosure relates to protecting or shielding seeds with a coating to provide the underlying seed with an insulating barrier against extreme weather conditions, protection against harmful insects, and moisture and freeze protection from harmful environment factors known to or might occur outside the growing season. In addition, the method of the present disclosure also relates to providing a coated particle where the coating protects or shields the underlying particle from environmental degradation during shipping and/or storage and until planting. Accordingly, a coated particle (obtained after the coating method) includes a seed and an outer layer of coating material that covers the seed partly or entirely.

### Coating Formulation

The coating may be formed from a coating formulation that includes one or more coating components. In one embodiment, the coating component is a polymer. In another embodiment, the polymer(s) may be crosslinked. In this aspect, the polymer may be thermoset. In yet another embodiment, the polymer may be thermoplastic. A non-limiting example of a suitable polymer for use in forming the coating formulation is a water-insoluble polymer. In this aspect, the polymer may have a solubility of less than about 0.10 g/L in deionized water at 100 kPa and 20° C. For example, the solubility of the polymer may less than about 0.05 g/L in deionized water at 100 kPa and 20° C. In one embodiment, the polymer has a solubility of less than about 0.01 g/L in deionized water at 100 kPa and 20° C. In another embodiment, the polymer is not soluble at 20° C. in deionized water using the method outlined in D. Braun et al., Practical Macromolecular Organic Chemistry, CRC Press, 1984, p. 73 wherein 30-50 mg samples of finely divided polymer are placed in small test tubes with 1 ml liquid and allowed to stand for several hours. In some embodiments, the coating includes a resin. In this regard, the coating may include one or more polymers and/or one or more additives.

In one embodiment, the coating is a polyurethane coating. In this aspect, the number ratio of NCO to OH groups may range from 0.8:10 to 1.2:10. The components of such a polyurethane coating, i.e., the components that are added to the coating unit to form the coating around the seed components, include a polyisocyanate and a polyol. The polyisocyanate may have two or more isocyanate groups per molecule and may be aliphatic or aromatic. In one embodiment, the polyisocyanate is aromatic. In another embodiment, the polyisocyanate may be a diisocyanate with exactly two isocyanate groups. Non-limiting examples of suitable polyisocyanates for use in forming the coating formulation of the present disclosure include methylene diphenyl diisocyanate (MDI), such as 4,4′-MDI, toluene diisocyanate (TDI), and combinations thereof. An example of an aromatic polyisocyanate is a blend of polymeric and di-isomers of the isocyanate.

The polyol may have at least two hydroxyl groups per molecule, 2-5 hydroxyl groups, or 3-4 hydroxyl groups. The polyol may be based on a polyether, polyester, or natural oil. In one embodiment, the polyol is based on a polyether. In some embodiments, the polyol has a hydroxyl number of 150-700 and an average functionality of 3. In this aspect, a polypropylene polyol or polyethylene polyol with hydroxyl number 150-700 and functionality of 3 or 4 may be used, as these provide for relatively short chain lengths (e.g., molecular weight 300-700 Da) and may contribute to lower viscosity of the polyol. In one embodiment, the polyol has a viscosity of less than 2000 or less than 1000 mPa·s at 25° C. and typically more than 100 mPa·s at 25° C.

In other embodiments, the polyol is an aliphatic polyether polyol, such as a polyol formed from an initiator and a plurality of alkylene oxide units. The polyol may be initiated from a compound with 3 hydroxyl groups such as glycerol, amine-initiated, or a combination thereof. In still other embodiments, the polyol is a polyethylene oxide, a polypropylene oxide polyol, or other polyether polyol. Polyester polyols can also be used.

The polyol and polyisocyanate components may be selected such that the cure time is short, i.e., less than about 5 minutes at 25° C., at 70° C., and/or at the temperature the coating is applied, thereby allowing subsequent application of coating layers, if appliable, at intervals of less than about 5 minutes. The amount and type of catalyst can be adjusted accordingly for such cure time. In one embodiment, the polyol and polyisocyanate components are selected such that the cure time is less than about 2 minutes at 25° C., at 70° C., and/or at the temperature the coating is applied.

In some embodiments, the coating is a polyester coating, more preferably a thermoset polyester coating. In this aspect, the coating components can include an unsaturated polyester (include a carbon-carbon double bond) and a vinyl monomer. The reaction of these components can involve copolymerization of the vinyl monomer and the unsaturated polyester. The unsaturated polymer may be the reaction product of a saturated dicarboxylic acid (or anhydride), an unsaturated dicarboxylic acid (or anhydride) with a polyol, such as a diol (glycol). The glycol may be ethylene glycol, propylene glycol, 1,3-butylene glycol, hydrogenated bisphenol A, or a combination thereof. The glycol may be cyclic or acyclic and aliphatic or aromatic. The glycol may have 2-30 C atoms. The vinyl monomer may be styrene. The reaction between the components may involve copolymerization of the unsaturated polyester and vinyl monomer, in the presence of a free radical initiator and a catalyst. The unsaturated polyester may be injected as liquid mixture with the vinyl monomer, wherein the vinyl monomer also acts as solvent for the polyester.

In other embodiments, the coating is a polyurea coating and the coating components include a polyisocyanate and a polyamine. The polyisocyanate may be any of the polyisocyanates discussed above with respect the polyurethane coating and the polyamine may have two or more amine groups per molecule, preferably 2-5 amine groups, and more preferably 3-4 amine groups.

In yet other embodiment, the coating is a phenolic resin coating and the coating components include a phenol and formaldehyde. The phenol component and formaldehyde component can react in the coating unit to form a thermoset polymer.

In still other embodiments, the coating is an epoxy coating and the coating components include an epoxy component (having epoxide groups) and an optional co-reactant having reactive groups such as a amine, acids and acid anhydrides, phenols, alcohols and thiols. The co-reactant may have two or more of the reactive groups per molecule, to provide for the formation of a thermoset polymer. The epoxy component may crosslink through homopolymerization in the second step (discussed in more detail below) or by the reaction with the optional co-reactants.

In some aspects, the coating formulation may include initiators and/or catalysts, such as polymerization initiators (e.g., free radical initiators or cationic initiators) and polymerization catalysts (e.g., organometallic catalysts, tertiary amines, and organic or inorganic bases). The amount and type of catalyst can be adjusted accordingly for a desired cure time.

As discussed with respect to the polyurethane coating, the coating components for any suitable coating formulation discussed herein may be selected such that the cure time is less than about five minutes at 25° C., at 70° C., and/or at the temperature the coating is applied. If subsequent coating layers are applied (discussed in more detail below), the intervals between the coating layers may be about five minutes or less. In one embodiment, the coating components are selected such that the cure time is less than about 2 minutes at 25° C., at 70° C., and/or at the temperature the coating is applied.

The coating components may have a reactivity at room temperature of between about 10 and 300 seconds (time needed for at least 50 percent cure). In one embodiment, the reactivity of the coating components is about 10 seconds to about 150 seconds. For example, the reactivity of the coating components at room temperature may be about 10 seconds to about 60 seconds. In another embodiment, the coating components have a reaction time at 25° C. of about 30 to 250 seconds (wherein the reaction time is the time necessary for hardening). In another embodiment, the coating components have a reactivity of between about 10 and 60 seconds at the operating temperature of the coating unit and/or at 55° C. In still another embodiment, the coating components have a reactivity of between about 10 and 120 seconds at the operating temperature of the coating unit and/or at about 55° C. to about 70° C. In yet another embodiment, the coating components have a reactivity of between about 10 and 60 seconds at the operating temperature of the coating unit and/or at about 55° C. to about 70° C. For example, the reactivity of the coating components at operating temperature may be about 10 to 45 seconds. As mentioned above with respect to the use of catalysts, the reaction time can be achieved or adjusted by varying the amounts and types of catalysts used for the curing or hardening.

In addition, the coating formulation may include wetting agents, surfactants, biocides, herbicides, insecticides, fungicides, antistatic agents, micronutrients, plant growth or health promoting additives, or combinations thereof. Non-limiting examples of suitable micronutrients for use in accordance with the present disclosure include Fe, Mn, Zn, Cu, Mo, Ni, Cl, Mg, and B.

The coating formulation may include less than about 5 percent by weight water and/or organic solvents based on the total weight of the coating formulation. In this aspect, organic solvents may include organic compounds having a boiling point lower than 120° C. In some embodiments, the coating formulation includes less than about 4 percent by weight water and/or organic solvents based on the total weight of the coating formulation. In other embodiments, the coating formulation includes less than about 3 percent by weight water and/or organic solvents based on the total weight of the coating formulation. In still other embodiments, the coating formulation includes less than about 1 percent by weight water and/or organic solvents based on the total weight of the coating formulation. In yet other embodiments, the coating formulation includes less than about 5 percent, 4 percent, 3 percent, 2 percent, or 1 percent by weight water and/or organic solvents based on the weight of the uncoated seed.

In some aspects, the coating formulation and/or one or more of the components therein has a viscosity of less than about 2000 mPa·s at 25° C. (as measured according to ISO 3219:1993) when applied to the seed components. In one embodiment, the coating formulation and/or one or more of the components therein has a viscosity of less than about 1000 mPa·s at 25° C. when applied to the seed components. In another embodiment, the coating formulation or one or more of the components therein have a viscosity of about 100 mPa·s or more at 25° C. In yet another embodiment, the coating formulation or one or more of the components therein have a viscosity of about 500 mPa·s or more at 25° C.

While the coating formulation can include additives as discussed, the coating formulation preferably includes less than about 40 percent by weight, less than about 30 percent by weight, less than about 20 percent by weight, or less than about 10 percent by weight (based on the total weight of the coating formulation) of components other than the reactants necessary for the chemical reaction to be carried out (as described in more detail below). In this aspect, should the coating formulation include wetting agents, surfactants, or the like, such additives may be present in the coating formulation in an amount of less than about 40 percent by weight based on the total weight of the coating formulation.

In one embodiment, the coating is water-impermeable. In some aspects, the coating protects the seed inside the coating from the environment until climatic conditions are sufficient to initiate seed germination at which time the coating ruptures and root and plant growth begins. In another embodiment, the coating is semipermeable (e.g., permeable for water and/or other solutes). When water enters through the coating due to osmosis, germination/swelling of the seed occurs, which can result in the coating cracking or bursting. In this aspect, sustained and/or delayed rupture of the coating material can be achieved.

In fact, unlike coated fertilizers (where the water penetrates the coating membrane allowing the fertilizer to turn into solution and be forced out of the pores of the coating), the coating on the finished coated seeds made in accordance with the present disclosure bursts once germination occurs because the underlying seed ruptures and roots start to form. As such, provided a coated seed is not subjected to climatic factors that define a growing season, it is contemplated that a coated seed made in accordance with the present disclosure will have an improved shelf life and a germination rate that is similar to or, in some cases, better than an uncoated seed. In this regard, an uncoated seed may have to be landfilled after the initial growing season because the germination rate in the second growing season may be significantly less, i.e., only about 90 percent or less of the initial germination rate. The coated seeds of the present disclosure not only have an initial germination rate that is comparable or better than the uncoated seed, the coated seeds also have a germination rate in the second growing season that is within about ±5 percent of the initial germination rate. In other words, the shelf-life of the coated seeds of the present disclosure is improved over the shelf-life of the uncoated seed.

In some embodiments, the coating itself contains plant nutrients that assist in plant development. In other embodiments, the coating includes stimulating growth additives, stress reducing additives, or a combination there to assist in plant stress reduction. In still other embodiment, the coating includes plant nutrients and stimulating growth additives or stress reducing additives.

The thickness of the coating (after applied to the seed) is about 1.0 μm to about 50 μm, in total and/or or per coating layer, although other thicknesses are also possible. In one embodiment, the thickness of the coating is about 5 μm to about 45 μm. In another embodiment, the thickness of the coating is about 10 μm to about 35 μm. In this aspect, the coating may include one or more layers, where each layer is formed form a coating formulation as described herein, and the coating formulation may be the same or different for each coating layer.

The coating, in total and/or or per coating layer, may be at least about 0.0010 percent by weight based on the total coated seed weight. In some aspects, the coating is about 0.10 percent to about 20 percent by weight based on the total coated seed weight. In other aspects, the coating is about 0.2 percent to about 15 percent by weight based on the total coated seed weight. In still other aspects, the coating is about 0.3 percent to about 10 percent by weight based on the total coated seed weight. In yet other aspects, the coating is about 1 percent to about 8 percent by weight based on the total coated seed weight. In still other aspects, the coating is about 0.5 percent to about 5 percent by weight based on the total coated seed weight.

In this aspect, a seed may have an initial coating merely for transport and/or storage purposes. For example, a relatively light coating may be useful to increase the stability of the uncoated seed so as to allow the coated seed to be transported and stored safely without degradation or damage. In addition, the light coating may allow for the coated seed to potentially be planted in the second growing season (rather than the first or initial growing season) with a germination rate that allows for a yield not otherwise achievable with an uncoated seed. In some embodiments, the coated seed may be planted prior to the second growing season and have a germination rate that is the same or substantially the same germination rate as if it had been planted for the first growing season. In other embodiments, the coated seed may be planted for the second growing season and have a germination rate that is the same or substantially the same germination rate as if it had been planted for the first growing season. In one embodiment, the coating may be about 0.1 percent to about 3 percent by weight based on the total coated seed weight. In another embodiment, the coating may be about 0.2 percent to about 2.5 percent by weight based on the total coated seed weight. In still another embodiment, the coating may be about 0.3 percent to about 2.0 percent by weight based on the total coated seed weight.

In addition, coated seeds may also be subjected to an additional coating process at a later time to add to the coating weight to improve or maintain the germination rate if planted outside of the normal growing season. For instance, a coated seed with a 1-2 percent by weight (based on the total coated seed weight) may be coated again to add further protection or insulation from extreme weather conditions, destructive insects, and/or moisture. As such, the coated seed may be subjected to (i) a first coating process at a first time to provide a first coating or layer with a first weight and (ii) a second coating process at a second time to provide a second coating or layer with a second weight. In some embodiments, the second weight is about 10 percent to about 50 percent of the first weight. In other embodiments, the second weight is about 50 percent to about 100 percent of the first weight. In one embodiment, the seed may have at least two coatings each applied at different times. In another embodiment, the seed may have at least three coatings each applied at different times. Each coating may have the same or different coating weights.

### Seed Component

The seeds may be used to grow crops that include, but are not limited to such as soybean seeds, cottonseed seeds, sunflower seeds, canola seeds, corn seed, rapeseed seeds, peanut seeds, and other fruit and vegetables grown commercially. The seeds may also include wheat, barley, milo, alfalfa, sorghum, cereal, clover, fescue, timothy, oats, bermuda, bluegrass and rye.

The seeds to be coated may have a particle size of about 0.10 mm to about 25 mm, such as about 0.5 mm to about 20 mm, about 1 mm to about 15 mm, about 5 mm to about 11 mm, or about 3 mm to about 10 mm. In this aspect, at least about 80 percent of the seeds to be coated have an average particle size in the above-described ranges.

In some aspects, the average size of the seed is at least about 85 percent of the average size of the coated particles. In other aspect, the average size of the seed is at least about 95 percent the average size of the coated particle. In still another aspect, the average size of the seed is at least about 99.5 percent of the average size of the coated particle.

The average size of the seed particle may range from about 0.25 mm to about 25 mm. In some embodiments, the average size of the seed particle size is about 1 mm to about 15 mm. In other embodiments, the average size of the seed particle size is about 3 mm to about 10 mm.

In some aspects, the average weight of the seed is at least about 80 percent of the average weight of the coated particle. In other aspect, the average weight of the seed is at least about 85 percent of the average weight of the coated particle. In still another aspect, the average weight of the seed is at least about 90 percent of the average weight of the coated particle. In still another aspect, the average weight of the seed is at least about 95 percent of the average weight of the coated particle.

### The Coating Unit

The coating unit may be any unit that is configured to receive and retain the seed components. In this aspect, the coating unit may have one or more exterior walls that define an interior space that is capable of receiving the seed components. In one embodiment, the coating unit may be a rotating container. In another embodiment, the coating unit includes one or more movable units to create a bed for the seed components. In this regard, the movable unit(s) in the coating unit cause the seed components to have a rolling action or by particle-to-particle contact. In some aspects, the bed is a lifted particles bed, wherein seed components are lifted by the motion of movable elements. In yet another embodiment, the coating unit includes a fluidized bed.

Other aspects and features of suitable coating units for use in making coated particles in accordance with the present disclosure are disclosed in U.S. Pat. No. 11,180,429, the entire disclosure of which is incorporated herein by reference. Briefly though, the coating unit may include a stationary frame and at least two movable elements (such as a container and an agitator) that can each move independently with respect to the frame and with rotating and/or reciprocating motion. The coating unit may also include actuators, an opening or inlet for the seed components, spray nozzles for one or more of the components of the coating formulation and/or additives, and a scraper. When one of the movable elements is a container, the container may be rotated at a speed of at least about 1 rpm but less than about 500 rpm, about 5 rpm to about 100 rpm.

In any of these aspects, the coating unit may operate in such a ways that all material charged to the interior space of the coating unit is kept in constant motion. In particular, in some embodiments, the coating unit is operable such that airborne particles are continually moved in multiple directions. In other embodiments, the coating steps discussed below are carried out in an atmosphere other than air, e.g., an inert atmosphere such as N₂. For example, the coating unit may be operated so that at least some particles are airborne and continually moved in multiple directions. Without being bound by any particular theory, the continual movement of the seed components and coated particles may help to overcome effects of gravity and may negate limitations of particle size, shape and density to achieve homogeneous mixing of the coating formulation with the seed components in short mixing cycles.

### Method of Making Coated Particles

In the first step of the method, the seed components are fed into the coating unit. In some embodiments, the seed components may be screened to a desired particle size before being introduced into the coating unit. In other embodiments, the seed components may be pre-heated before feeding into the coating unit. In this aspect, the seed components may be pre-heated to a temperature of at least about 30° C., at least about 40° C., at least about 50° C., at least about 60° C., or at least about 70° C. In other aspects, the seed components may be pre-heated before feeding into the coating unit to a temperature of about 5° C. to about 50° C. above ambient temperature. For example, the seed components may be pre-heated to a temperature of about 15° C. to about 40° C. In one embodiment, the seed components are pre-heated to a temperature of about 20° C. to about 30° C. In still other aspects, the seed components may be pre-heated to a temperature of about 15° C. to about 60° C. In one embodiment, the seed components are pre-heated to a temperature of about 20° C. to about 80° C.

The seed components may be fed into the coating unit in an amount of more than about 10 percent, more than about 20 percent, more than about 40 percent, or more than about 60 percent, and/or less than about 95 percent, less than about 90 percent, less than about 80 percent, of the volume of the interior space of the coating unit (based on the bulk density of the seed components). In one embodiment, the seed components are fed into the coating unit in an amount of about 60 percent to about 90 percent of the volume of the interior space of the coating unit. In another embodiment, the seed components are fed into the coating unit in an amount of about 75 percent to about 90 percent of the volume of the interior space of the coating unit. The volume fraction based on bulk density means that a bulk bed of the uncoated seed components (including void space in the bed) occupies the volume fraction of the interior space. Without being bound to any particular theory, this range of filling fractions can contribute to the formation of a lifted bed and to good distribution of the coating components.

Once the coating unit has been charged with the seed components, the component(s) of the coating formulation may be added to and allowed to react in the coating unit in the second step of the method. This second step may be carried out (and completed) in about 10 to about 600 seconds. In one embodiment, the second step is carried out in about 30 to about 240 seconds. For example, the second step may be carried out in about 30 to about 120 seconds or about 30 to about 90 seconds. In another embodiment, the second step is carried out in about 10 to about 120 seconds. For example, the second step may be carried out in about 10 to about 60 seconds or about 10 to about 30 seconds. In some embodiments, the coating component(s) is (are) added to the coating unit and, more specifically one of the movable elements in about 0.5 to about 30 seconds, about 1 to about 10 seconds, or about 1 to about 5 seconds. In other embodiments, the coating component(s) is (are) distributed over the seed components (i.e., mixed with the seed components) in about 5 to about 45 seconds or about 10 to about 30 seconds.

While this second step of the method is directed to the application of one coating layer, the step of applying a coating layer can be performed one or more times to provide coated particles having one or more coating layers. Also, other compounds and layers, e.g., solvents and wax layers, can be applied simultaneously or subsequently along with the coating application step if desired. For example, at least two coating layers (having the same or different coating formulations) may be applied stepwise. If this second step is performed two or more times to provide more than one coating layer in the coated particles, these times refer to one instance of the second step. Preferably step b) involves applying two or more coating components subsequently and stepwise to the seed particles while both the container and the rotor are rotating. Preferably the coating component added first to the particles has a higher molecular weight (such as number average molecular weight) and/or higher viscosity than the second coating component. Preferably the first coating component is added to the particles and mixed for 2-120 seconds, such as 10-60 seconds, and then the second coating component is added. The mixing of the first coating component preferably provides for a homogeneous distribution of the coating component over the particles at the end of the mixing period and before the second coating component is added. Preferably both coating components are injected as liquids (which can include dripping and spraying) and preferably to a bed of lifted particles. In a preferred embodiment, the bed of lifted particles contains a zone wherein the particles move the fastest (e.g. close to the rotor) and the coating component is added to that part. This may provide for achieving even distribution of the coating component over the particles quickly. In some embodiments, the first two coating components which are added are reactive with each other. After the one or more reactive coating components are applied, the method may involve allowing the coating components to react. with each other for instance for a period of 10 to 300 seconds, such as 10 to 120 seconds, while the particles are kept in motion. An advantage of the present invention is that this reaction carried out in the coating unit may provide for curing or hardening of the particles without agglomeration of the coated particles.

Moreover, as discussed above, an uncoated seed may be subjected to (i) a first coating process as described herein at a first time to provide a coated seed with a first coating or layer with a first weight and (ii) at least one additional coating process at a later time to build upon the first coating with at least one additional coating layer and a total coating thickness that has a second weight greater than the first weight. For example, an uncoated seed may be protected with a first coating having about 1 to about 3 percent by weight of the total coated seed for storage and stability purposes. At a later date, at least one additional coating layer may be added to the already-coated seed to increase the overall coating weight to greater than the weight of the first coating.

The coating formulation(s) may be applied as a liquid. In this aspect, the liquid may be in the form of an emulsion, solution, or a dispersion. In other embodiments, the coating formulation may be applied as a polymer melt, e.g., at a temperature sufficiently above the glass transition temperature of the polymer such that the polymer has sufficiently low viscosity.

The first and second steps of the method may be carried out at a temperature ranging from about 10° C. to about 120° C. In one embodiment, the first and second steps of the method are carried out at a temperature of at least about 10° C., at least about 30° C., at least about 40° C., at least about 50° C., at least about 55° C., at least about 60° C., or at least about 70° C. In another embodiment, the first and second steps of the method are carried out at a temperature of less than about 120° C. or less than about 80° C. For example, the first and second steps of the method may be carried out at a temperature range of about 40° C. to about 120° C., about 50° C. to about 100° C., or about 55° C. to about 80° C.

The third step of the method also involves at least partially curing or hardening the one or more coating layers. The curing or hardening step involves chemical reaction of the one or more components in the coating formulation while in the coating unit. The coated particles are kept in motion during curing. The chemical reaction may provide for the polymerization and/or cross-linking of polymers, an increase in the viscosity of the coating layer, or both. In this regard, the chemical reaction may involve crosslinking to form a thermoset polymer or may not involve crosslinking to form a thermoplastic polymer. Moreover, when the coating formulation is formed from only one reactant/component, the component reacts with itself, e.g., in a polymerization reaction. As discussed previously, initiators and/or catalysts may be used to effect curing or hardening. In one embodiment, the third step is carried out (and completed) in about 60 seconds to about 10 minutes. For example, the third step may be carried out in about 2 to about 8 minutes. In another embodiment, the third step is carried out in about 1 minute to about 6 minutes.

Depending on the degree of cure, further curing or hardening may be carried out subsequent to the third step, i.e., in a fourth step, before and/or after discharge of coated particles from the coating unit. The optional final curing or hardening step is applied to bring the coated particles in condition for discharge, e.g., non-sticky and with sufficient mechanical/crushing strength to be handled, packaged and stored. A final hardening step may include evaporation of unreacted monomer, or cooling, and/or a final hardening chemical reaction step. A final cure step may include allowing the coating components present in the applied coating layers to further react (with or without initiators or catalysts). In this aspect, the final curing step may involve crosslinking of polymeric coating material. In one embodiment, the final curing or hardening step is carried out in the same or different coating unit as used for the second and/or third steps of the method.

In one embodiment, the fourth step is carried out (and completed) in about 1 minute to about 15 minutes. For example, the fourth step may be carried out in about 2 to about 12 minutes. In another embodiment, the fourth step is carried out in about 1 minute to about 8 minutes. In still another embodiment, the fourth step is carried out in about 2 to about 5 minutes.

The residence time in the coating unit may be about 30 minutes or less. In one embodiment, the residence time is about 20 minutes or less. In second embodiment, the residence time is about 15 minutes or less. In another embodiment, the residence time is about 10 minutes or less. In still another embodiment, the residence time is about 5 minutes or less.

If additional components are used, e.g., wetting agents, surfactants, or the like, as discussed above, such components may be added to the coating unit in the second step with the other components in the coating formulation, or in the third step, i.e., the curing or hardening step.

The coating can include wax, which may be applied as a layer between coating layers that are cured or hardened during the third step and/or as final layer. The wax may be an olefin wax. In one embodiment, the wax is an alpha-olefin wax with at least 20 carbon atoms. In another embodiment, the wax is an alpha-olefin wax with at least 30 carbon atoms. In this aspect, the wax may be a hydrocarbon (such as alkane) 20 to 40 carbon atoms. The wax may also be a paraffin wax, a petrolatum wax, a polyamide wax, or a combination thereof. In one embodiment, the wax is a microcrystalline wax.

The method also includes discharging the coated particles from the coating unit. In one embodiment, the coated particles are at least about 50° C. when discharged from the coating unit. After being discharged, the coated particles may be subjected to additional steps including, but not limited to, a cooling step, a packaging step, a metering step, a storage step, or a combination thereof. For example, the coated particles may be cooled from the exit temperature (e.g., about 75° C. or higher) to about 40° C. or lower. In this aspect, the cooling step may include suspending the coated particles in cooling air. The packaging step may include packaging the coated particles in bags or containers. The metering step may involve dividing a stream of coated particles in batches of a metered amount so that batches may be transferred to a desired mode of transportation (with or without packaging).

The coating method described herein may be carried out as batch process or as continuous process. For example, a batch process may be used to produce coated particles with multiple coating layers, i.e., wherein two or more steps of applying a coating layer are carried out in the same coating unit. In addition, for a batch process, the one or more components of the coating formulation may be added continuously over a time period of about 10 seconds or more. Two or more batch coating units may be operated in parallel, with the parallel coating units carrying out different steps from each other at the same time. In such an embodiment, the method of the present disclosure may be carried out in a batch-continuous or semi-continuous mode. In this aspect, the method may involve charging a first coating unit with seed components and applying the coating layer(s) while a second coating unit carries out a different step. In such embodiment, the method may involve applying the total number of coating layers to be applied on the seed components (e.g., 1, 2, 3, or more layers) in a single one of the parallel coating units.

In one embodiment, the method is carried out as a continuous process such that two or more coating layers are applied in different coating units arranged in series, and the partially coated seed components are transported from a first coating unit after application of a first coating layer to a second coating unit for application of a second coating layer. Transporting may be accomplished with a moving belt, or coating units may be placed on top of each other such that transporting is carried out by gravity. The continuous process may involve continuous supply of seed components to a first coating unit and transfer of partially coated particles (i.e., seed components having a coating layer from the first coating unit to a downstream second coating unit and withdrawal of partially coated particles having an additional coating layer from the second coating unit. In other embodiments, two or more coating units as described are used in series, wherein different coating layers are applied stepwise in different coating units, and wherein the transportation involves transporting batches of coated particles at least from a first coating unit to a downstream second coating unit.

In such embodiments, the coating unit may include a plurality of coating devices, arranged in series or in parallel, wherein each coating device includes a container and at least one rotor. For example, the coating unit may include a plurality of coating devices, arranged in series and connected with each other with transport lines for coated or partially coated particles (such as moving belts or ducts), wherein each coating device has one container. Each container has for instance an inlet and outlet for coated particles. In another embodiment, a coating system is used with a plurality of coating units in parallel, and with a common cooling stage downstream of the coating units.

In a non-limiting example, the coating unit includes a container and a rotor as the two movable elements, the coating is a polyurethane coating, and the second step includes subsequently (after each other, but optionally with further steps before, in between, and/or after):
1) injecting a polyol into a bed of seeds in the container, where the seeds in the bed may be lifted by the motion of the container and the rotor, and where the injecting may be with an open pipe or with a spray nozzle;
2) mixing the polyol with the seeds for about 5 to about 120 seconds, preferably about 10 to about 60 seconds;
3) injecting a polyisocyanate component into the bed of seeds in the container, where the injecting may be with an open pipe or a spray nozzle; and
4) rolling the seeds in the container for at least about 10 to about 300 seconds, preferably about 20 to about 180 seconds, which allows the polyol and the polyisocyanate components to react with each other and to at least partially cure the coating layer.
5) injecting a wax, which may be applied as a layer after each polyol and polyisocyanate coating layer in the bed of seeds in the container, where the injecting may be with an open pipe or a spray nozzle; and
6) rolling the seeds in the container for at least about 10 to about 120 seconds, preferably about 20 to about 60 seconds, which allows the wax melt to spread evenly over the coated seed particles.

Predetermined amounts of polyol, polyisocyanate, and wax are injected in sequence over a number of coating steps to produce a coated seed with the desired coating concentration. In one embodiment, the step of injecting the coating components may be reversed, i.e., the step of injecting a polyisocyanate component may occur before the steps of injecting and mixing the polyol. In another embodiment, the step of injecting a wax before the polyol component may occur before the steps of injecting and mixing the polyisocyanate. In still another embodiment, the step of injecting a wax before the polyisocyanate component may occur before the steps of injecting and mixing the polyol. Of course, other coating components may be substituted for the polyol and/or polyisocyanate and/or wax to provide a coating formed from any of the other suitable coatings discussed above. In the rolling step, the coating unit and its movable elements may be rotated or otherwise manipulated to effect rolling of the seeds.

The coating method of the present disclosure provides several advantages over the prior art including, but not limited to avoiding damage of the seed components, faster reaction times, and no agglomeration of the particles. As discussed below, the coated particles produced by the method provide more flexibility for planting cycles in various geographical areas and higher yield. The coated seeds made in accordance with the present disclosure allow a farmer to plant at least one season before the growing season and also plant additional acreage for additional production.

### Finished Coated Particles

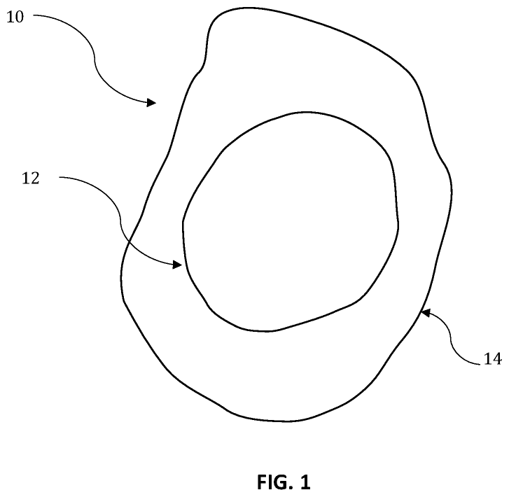

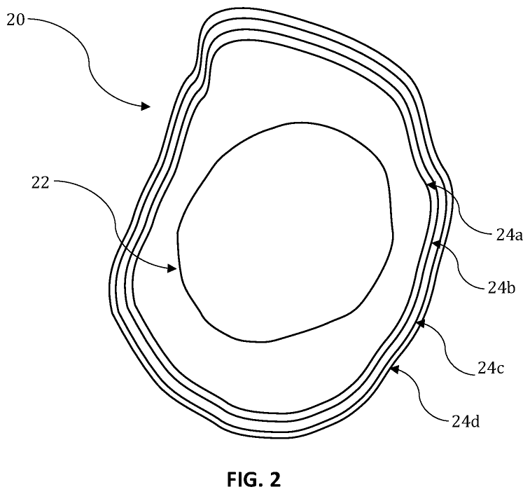

As shown in FIG. 1, a finished coated particle 10 include at least a core component 12 that includes a seed and a protective coating layer 14 including multiple layers. In this aspect, the protective coating layer 14 may include one or more layers of cured and hardened polyol, polyisocyanate, and wax. In some embodiments, the coating layer 14 applied in the second step in an amount of about 0.10 to about 20 weight percent, about 0.2 to about 15 weight percent, about 0.3 to about 10 weight percent or about 0.5 to about 5 weight percent based on the weight of the seed component. If the second step, i.e., the coating step, is performed two or more times, these amounts refer to one instance of the second step. For example, if there are four coating layers, each individual coating level may be about 0.025 to about 5 weight percent, about 0.05 to about 3.75 weight percent, about 0.075 to about 2.5 weight percent about 0.125 to about 1.25 weight percent, based on weight of the seed component. A finished coated particle with four such coating layers is shown in FIG. 2. In particular, a finished coated particle 20 may include at least a core component 22 that includes a seed and four coatings layers 24a, 24b, 24c, and 24d.

The coated particles have a controlled rupture rate. In other words, the coating may protect the seed until a predetermined time such that the seed has a longer period of dormancy than conventionally experienced. In fact, coated seeds in accordance with the present disclosure have an initial germination rate, i.e., the germination rate in the first growing season, which is comparable or better than the uncoated seed and also have a germination rate in the second growing season that is at least about 90 percent of the initial germination rate. In some embodiments, coated seeds in accordance with the present disclosure have an initial germination rate that is comparable or better than the uncoated seed and also have a germination rate in the second growing season that is at least about 50 percent of the initial germination rate.

A crop of coated seeds may have a germination rate of at least about 50 percent regardless when planted. In other words, for every 100 coated seeds planted, at least 50 of those coated seeds will germinate regardless of whether those coated seeds are planted well before the growing season or stored through a growing season and not planted until the second growing season (or prior to the second growing season). In some embodiments, a crop of coated seeds may have a germination rate of at least about 60 percent. In other embodiments, a crop of coated seeds may have a germination rate of at least about 70 percent. In still other embodiments, a crop of coated seeds may have a germination rate of at least about 80 percent. Without being bound to any particular theory, if a crop of 160,000 coated soybeans are planted in the fall, at least about 80,000 plants will grow in the spring. And, because these plants will adapt and expand over time, any empty spaces from coated seeds that failed to germinate will be consumed by the plants surrounding the empty spaces. Accordingly, a grower may take advantage of land otherwise unused because of logistical issues that might arise during the normal planting time (e.g., time, labor, weather) by planting a crop of coated seeds made in accordance with the present disclosure before the normal planting time because the coating will protect the crop such that at least 50 percent of those coated seeds will germinate in the growing season.

In some aspects, the controlled rupture rate is based on the thickness or weight percent of the coating applied to the seeds. In this regard, the coated particles may have a rupture rate of at least about 20 days after planting in soil. In one embodiment, the coated seeds may have a delayed rupture/germination rate of at least about 90 days after planting in soil. In another embodiment, the delayed rupture/germination rate is at least about 120 day after planting in soil. In another embodiment, the delayed rupture/germination rate is at least about 150 days after planting in soil. In another embodiment, the delayed rupture/germination rate is at least about 180 days after planting in soil. In still another embodiment, the delayed rupture/germination rate is at least about 210 days after planting in soil.

The rupture rate may be further controlled for certain geographical areas. In this aspect, the thickness or weight percent of the coating may be adjusted for planting in different climates. In varying geographical areas, there are many factors that influence the timing and rate at which a seed germinates. For example, environmental factors such as the length of a growing season, the number of hours of sunlight in a day, the temperature of the soil, the soil type and mineral structure, the soil pH, and the soil moisture holding capacity all influence on seed germination. In addition, there are factors that could have a negative impact on the planted seeds during the desired dormancy period such as seed planting depth, excessive water/flooding (which could cause seed rot), wet freezing conditions (which could damage the seed protective membrane), seed parchment due to excessive heat, and/or soil insect attachment. The coating advantageously provides an insulating barrier for the seed against extreme weather conditions, guards against harmful insects, and protects the seed from moisture and/or freezing conditions, especially for seeds that are planted prior to the growing season, e.g., in late fall and winter. In this aspect, the coating on the seed would have a controllable rupture rate that promotes and/or facilitates germination in the primary growing season.

In this aspect, the coated particles of the present disclosure increase the dormancy of a seed (from planting in soil to germination) by at least about 70 percent as compared to the uncoated seed. In one embodiment, the dormancy of the seed is increased by at least about 80 percent over that of the uncoated seed. In another embodiment, the dormancy of the seed is increased by at least about 95 percent over that of the uncoated seed.

### EXAMPLE

The following example does not limit the invention or the claimed subject-matter. Rather, the example is intended to further illustrate an embodiment of the present disclosure.

### Example 1: Coated Soybean Trial in Northern Kentucky 2021-2022

Uncoated soybean seed received an 8 percent total coating by weight of polyurethane/wax. A population of this coated soybean seed was planted in the late fall before the normal spring growing season in Northern Kentucky. The coated soybean seed survived the fall and winter months and germination/plant emergence was observed during the first few weeks of the spring growing season, which was about 150-160 days after planting.

A control population of uncoated soybeans were then planted during the spring growing season. Uncoated soybean seed typically germinates and emerges from the soil within 2-7 days after planting when favorable environmental conditions are in place to promote seed germination.

Both plant populations were monitored and evaluated by a research agronomist. After about 7-14 days from planting of the uncoated soybean seeds, the plant population from the coated soybean seeds planted before the spring growing season was comparable to the plant population from the uncoated soybean seeds planted during the spring growing season.

The description herein illustrates and describes the formulations, processes, and finished articles of the present disclosure. While the disclosure shows and describes only certain embodiments, as mentioned above, it is to be understood that the teachings of the present disclosure are capable of use in various other combinations, modifications, and environments and are capable of changes or modifications within the scope of the teachings as expressed herein, commensurate with the skill and/or knowledge of a person having ordinary skill in the relevant art. Accordingly, the teachings of the present disclosure are not intended to limit the exact embodiments and examples disclosed herein. Any section headings herein are provided only for consistency with the suggestions of 37 C.F.R. § 1.77 or otherwise to provide organizational queues. These headings shall not limit or characterize the invention(s) set forth herein.

What is claimed is:

1. A coated seed, comprising:
a core comprising a seed having a first germination rate;
a coating comprising a polyurethane, where the coating has a rupture rate of at about 20 days to 180 days after being planted in soil, wherein the coated seed has a second germination rate.

2. The coated seed of claim 1, wherein the coating has a weight of about 0.3 percent to about 10 percent by weight based on the total weight of the coating.

3. The coated seed of claim 2, wherein the coating has a weight of about 1 percent to about 8 percent by weight based on the total weight of the coating.

4. The coated seed of claim 1, wherein the coating has a weight of about 0.1 percent to about 20 percent by weight based on the total coated seed weight.

5. The coated seed of claim 4, wherein the coating has a weight of about 0.2 percent to about 15 percent by weight based on the total coated seed weight.

6. The coated seed of claim 5, wherein the coating has a weight of about 0.5 percent to about 5 percent by weight based on the total coated seed weight.

7. The coated seed of claim 1, wherein the second germination rate is substantially equivalent to or better than the first germination rate.

8. The coated seed of claim 1, wherein the second germination rate is about 97 percent to about 100 percent of the first germination rate.

9. The coated seed of claim 1, wherein the second germination rate is about 99 percent to about 105 percent of the first germination rate.

10. The coated seed of claim 1, wherein the second germination rate is about 100 percent to about 115 percent of the first germination rate.

11. The coated seed of claim 1, wherein the second germination rate is about 97 percent to about 110 percent of the first germination rate.

12. The method of claim 1, wherein the second germination rate is at least 50 percent of the first germination rate.

13. A method of coating seeds, wherein the method comprises:
feeding a plurality of uncoated seeds into a coating unit, wherein the plurality of uncoated seeds have a first germination rate;
applying a coating layer to each uncoated seed in the plurality of uncoated seeds by:
disposing a coating layer on each uncoated seed, wherein the coating layer has a first weight, and wherein the coating layer comprises the reaction product of one or more coating components;
partially curing or hardening the coating layer, wherein the step of disposing is performed one or more times to the plurality of uncoated seeds to provide a plurality of coated seeds; and
discharging the plurality of coated seeds from the coating unit, wherein the plurality of coated seeds have a second germination rate.

14. The method of claim 13, further comprising a step of performing a final cure or hardening of the coating layer on each coated seed in the plurality of coated seeds, and wherein the step of performing occurs prior to the step of discharging the plurality of coated seeds from the coating unit.

15. The method of claim 13, wherein the second germination rate is substantially the same as or greater than first germination rate.

16. The method of claim 13, wherein the second germination rate is at least 50 percent of the first germination rate.

17. The method of claim 13, wherein the one or more coating components comprises a polyisocyanate and an isocyanate-reactive component, and wherein the step of applying a coating layer further comprises the steps of:
injecting the isocyanate-reactive component into a bed of the plurality of uncoated seeds;
mixing the isocyanate-reactive component with the plurality of uncoated seeds for about 5 to about 120 seconds;
injecting the polyisocyanate into the bed of the plurality of uncoated seeds;
rolling the plurality of uncoated seeds in the coating unit for about 10 seconds to about 300 seconds, allowing the isocyanate-reactive component and the polyisocyanate to react; and
injecting a liquid wax into the coating unit.

18. The method of claim 17, wherein the isocyanate-reactive component comprises a polyol.

19. The method of claim 13, wherein the coating has a weight of about 0.1 percent to about 20 percent by weight based on the total coated seed weight.

20. The method of claim 19, wherein the coating has a weight of about 0.2 percent to about 15 percent by weight based on the total coated seed weight.

21. The method of claim 19, wherein the coating has a weight of about 1 percent to about 10 percent by weight based on the total coated seed weight.

22. The method of claim 19, wherein the coating has a weight of about 0.5 percent to about 5 percent by weight based on the total coated seed weight.
